(19) United States
(12) Patent Application Publication
(10) Pub. No.: US 2009/0084179 A1
(43) Pub. Date: Apr. 2, 2009

(54) Measuring rings

(76) Inventor: Susan Lucia Gougian, Pepperell, MA (US)

Correspondence Address: Susan Gougian, 15 Cross Street, Pepperell, MA, 01463, US

(21) Appl. No.: 11/906,011

(22) Filed: Sep. 29, 2007

(51) Int. Cl. G01F 19/00

(52) U.S. Cl. 73/427

(57) ABSTRACT

A set of six measuring rings each one comprising of a single piece of non flexible material. A set of six measuring rings each one to be used for measuring prepared food products. A set of six measuring rings to be used as a guide to correct serving sizes for food according to the recommendations set forth by the United States Food and Drug Administration and the American Diabetes Association.

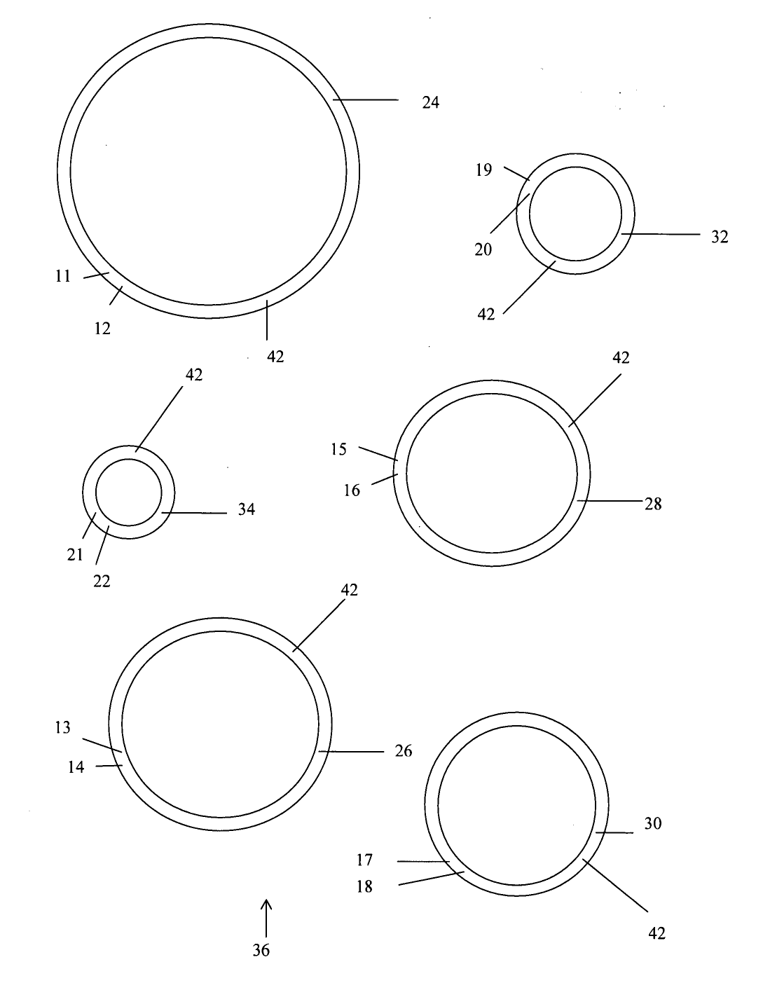

### CROSS-REFERENCE TO RELATED APPLICATIONS

Not Applicable

### STATEMENT REGARDING FEDERALLY SPONSORED RESEARCH OF DEVELOPMENT

Not Applicable

### REFERENCE TO MIROFICHE APPENDIX

Not Applicable

### BACKGROUND OF THE INVENTION

1. Field of the Invention

The present invention relates to a measuring cup used in kitchens during food preparation. The present invention relates to a measuring cup comprised a single piece of non flexible material.

2. Description of the Prior Art

A conventional measuring cup is usually in the form of a container having a handle and a solid bottom. A conventional measuring cup usually has one or more scale markings used to designate one volume or several volumes. A conventional measuring cup is usually in the shape of a cylinder. A conventional measuring cup is used in kitchens to measure food products during food preparation.

The present invention is a measuring ring to be used to measure prepared food at the time of serving. The measuring ring is to be placed on a plate or in a bowl. The food being measured by placing the food into the measuring ring until the ring is filled to scale. The present invention is a guide to the correct serving sizes for food.

### BRIEF SUMMARY OF THE INVENTION

The measuring rings are simply constructed and each ring is comprised of a single piece of non flexible material formed into a circular shape. The measuring rings, when filled to scale, each having a specific volume, being 1 cup, ¾ cup, ⅔ cup, ⅓ cup, 3 ounces and 1 ounce. The measuring rings function as measuring tools and as a guide to the correct serving sizes for food according to the recommendations of the United States Food and Drug Administration and the American Diabetes Association.

### BRIEF SUMMARY OF THE DRAWING

A plan view of measuring rings according to the present invention.

### DETAILED DESCRIPTION OF THE INVENTION

Referring to the drawing, the material for the measuring rings 36 is furnished preferably by plastic including polyethylene, polypropylene or polycarbonate, but can be comprised of natural or man made materials, selected from a group consisting of wood, earthenware, porcelain, and metal, including aluminum, stainless steel, brass, copper or a combination thereof.

Referring to the drawing, each of the measuring rings 24, 26, 28, 30, 32, 34 is comprised of a single piece of non flexible material, preferably plastic, formed into a circular shape. Where plastic is used, metal molds are needed to manufacture the measuring rings. The metal molds should be made preferably using a tool or machine well known in the art. The metal molds should each preferably be comprised of one individual cavity, each having specific dimensions necessary to manufacture each distinct measuring ring. The metal molds preferably having scale markings, necessary to designate a specific volume on each of the measuring rings.

Where plastic is used, plastic pellets should be poured into a specialized machine well known in the art, to be melted and poured in to each distinct mold to harden and to form each distinct measuring ring.

Preferred dimensions for the measuring rings 24, 26, 28, 30, 32, 34 will be given for instructional purposes, but not as a limitation. The plastic material 42 being about 1/16 inch thick. The 1 cup measuring ring being about 4 ½ in diameter and about ⅞ inch in height. The ¾ cup measuring ring being about 3 ½ inches in diameter and about 1 inch in height. The ½ cup measuring ring being about 3 inches in diameter and about 1 inch in height. The ⅓ cup measuring ring being about 2 ½ inches in diameter and about ¾ inch in height. The 3 ounce measuring ring being about 4 inches in diameter and about ¼ inch in height. The 1 ounce measuring ring being about 2 inches in diameter and about ¼ inch in height.

The preferred dimensions for the measuring rings 24, 26, 28, 30, 32, 34 allow for the measuring rings to fit, one inside of the other, from the smallest to the largest, for easy storage.

Where plastic is used, colored plastic is preferred. Where colored plastic is used, each measuring ring should be formed in a specific color for easy identification. The 1 cup measuring ring 24, to be used to measure raw vegetables should be formed using dark green plastic. The ¾ cup measuring ring 26 to be used to measure grains should be formed using dark yellow plastic. The ½ cup measuring ring 28 to be used to measure cooked vegetables should be formed using light green plastic. The ⅓ cup measuring ring 30 to be used to measure rice should be formed using white plastic. The 3 ounce measuring ring 32 to be used to measure meat should be formed using red plastic. The 1 ounce measuring ring 34 to be used to measure cheese should be formed using light yellow plastic.

Referring to the drawing, reference numeral 24 is used to identify the 1 cup measuring ring, having a first end 11 adjoining an opposite second end 12. Referring to the drawing, reference numeral 26 is used to identify the ¾ cup measuring ring, having a first end 13 adjoining an opposite second end 14. Referring to the drawing, reference numeral 28 is used to identify the ½ cup measuring ring, having a first end 15 adjoining an opposite second end 16. Referring to the drawing, reference numeral 30 is used to identify the ⅓ cup measuring ring, having a first end 17 adjoining an opposite second end 18. Referring to the drawing, reference numeral 32 is used to identify the 3 ounce measuring ring, having a first end 19 adjoining an opposite second end 20. Referring to the drawing, reference numeral 34 is used to identify the 1 ounce measuring ring, having a first end 21 adjoining an opposite second end 22.

Another embodiment of the measuring rings 24, 26, 28, 30, 32, 34 may be accomplished by using rectangular shaped metal molds in which to form each one of the measuring rings. Another embodiment of the measuring rings 24, 26, 28, 30, 32, 34 may be accomplished by using oval shaped metal molds in which to form each one of the measuring rings.

The above description of the preferred embodiment of the present invention may be changed or modified by those skilled in the art, to which the invention appertains, without departing from scope of the invention, which is intended to be limited only by the scope of the claims.

Instructions for use will now be given for the present invention measuring rings 24, 26, 28, 30, 32, 34. The measuring ring selected for use is to be placed on a plate or in a bowl. The food being measured should be placed into the measuring ring until the ring is filled to scale. The measuring ring should be removed from the plate or bowl leaving a correct serving size of food on the plate or in the bowl. Several rings may be placed on the same plate to measure food at the time of serving a meal.

I claim:

1. (canceled)

2. (canceled)

3. (canceled)

4. (canceled)

5. (canceled)

6. (canceled)

7. (canceled)

8. (canceled)

9. (canceled)

10. (canceled)

11. A prepared food measuring tool, comprising:
a) a plurality of plastic rings,
b) said plastic rings, each having a different size and a different color.

12. A prepared food measuring tool of claim 11, wherein said plastic rings are made of plastic, selected from a group of plastic including polyethylene, polypropylene or polycarbonate, or a combination thereof.

13. A prepared food measuring tool of claim 11, each ring having a specific volume and scale markings to designate the same.

14. A prepared food measuring tool of claim 11, each ring having specific dimensions to allow the rings to nest, each ring around the other.
